(19) United States
(12) Patent Application Publication
(10) Pub. No.: US 2004/0188332 A1
(43) Pub. Date: Sep. 30, 2004

(54) Self-cleaning filter system within reaction or retention vessels

(75) Inventor: Frederick J. Haydock, Murray, UT (US)

Correspondence Address: Lloyd W. Sadler, Parsons Behle & Latimer, Suite 1800, 201 South Main Street, Salt Lake City, UT, 84111, US

(73) Assignee: Haydock Intellectual Properties, L.L.C., Murray, UT

(21) Appl. No.: 10/404,965

(22) Filed: Mar. 31, 2003

(51) Int. Cl. B01D 35/00

(52) U.S. Cl. 210/106; 210/383; 210/435; 210/407

(57) ABSTRACT

A self-cleaning/self-purging ceramic, telflon-copolymer composite filter capable of continuous and/or intermittent cleaning and suitable for installation within a reaction or precipitation vessel. The filter can be cleaned either continuously or intermittently by ultra sound vibration and/or backpressure within the filter system. This invention is appropriate for use in industrial, pharmaceutical, commercial and municipal processing and/or wastewater treatment applications where the removal of undesired contaminants is desired.

### BACKGROUND OF INVENTION

1. Field of the Invention

This invention relates to filters. More specifically, this invention relates to filters designed to fit within a precipitation or reaction vessel.

2. Description of Related Art

A variety of filters and filter systems are well known in the art. However, generally these prior filters and filter systems are not self-cleaning and self-purging and therefore cannot be continuously operated.

Although these documents may not constitute “prior art”, the reader is referred to the following U.S. patent documents for general background material. Each of these documents is hereby incorporated by reference in its entirety for the material contained therein.

U.S. Pat. No. 3,931,012 describes a sewage treatment system and components thereof.

U.S. Pat. No. 4,161,481 describes a process for the isolation of purified anthraquinone.

U.S. Pat. No. 4,213,863 describes a flow-through coalescing separator applicable to clean immiscible liquids.

U.S. Pat. No. 4,405,449 describes a vapor-liquid contacting process for use in gas treating, absorption or in fractional distillation.

U.S. Pat. Nos. 5,160,624, 5,173,188, 5,198,197, 5,250,195, 5,296,145 and 5,296,145 describe apparatus and methods for supercritical fluid extraction that incorporates a removable extraction cartridge.

U.S. Pat. No. 5,404,210 describes the continuous purification of liquid toners.

U.S. Pat. No. U.S. 6,503,740 B1 describes a treatment media capable of acting upon at least one chemical contaminant in an aqueous composition and assisting in the decomposition thereof.

### SUMMARY OF INVENTION

It is desirable to provide a filtration system that is self-cleaning and self-purging. It is particularly desirable to provide a filtration system that can be continuously or intermittently cleaned by either ultra-sound or from pressure within the vessel.

Accordingly, is an object of this invention to provide a self-cleaning, self-purging filter.

Another object of this invention is to provide a self-cleaning, self-purging filter that uses a composite or ceramic filter element as an integral part of a reaction or precipitation vessel.

A further object of this invention is to provide a self-cleaning, self-purging filter that can be continuously or intermittently cleaned using ultra-sound or pressure from within the vessel.

A still further object of this invention is to provide a self-cleaning, self-purging filter that is compatible with use in industrial, pharmaceutical, commercial and municipal process or wastewater treatment applications.

It is another object of this invention to provide a self-cleaning, self-purging filter that can be cleaned while in use.

It is a further object of this invention to provide a self-cleaning, self-purging filter that is enclosed within the reaction or precipitation vessel.

It is also an object of this invention to provide a self-cleaning, self-purging filter that can reduce the operating cost, operating time, and the need for additional filtering vessels or filtration systems.

Additional objects, advantages and other novel features of this invention will be set forth in part in the description that follows and in part will be apparent to those skilled in the art upon examination of the following or may be learned with the practice of the invention. The objects and advantages of this invention may be realized and attained by means of the instrumentalities and combinations particularly pointed out in the appended claims. Still other objects of the present invention will become readily apparent to those skilled in the art from the following description wherein there is shown and described present preferred embodiments of the invention, simply by way of illustration of the best modes currently known to carry out this invention. As it will be realized, this invention is capable of other different embodiments, and its several details, and specific steps and components, are capable of modification in various aspects without departing from the invention. Accordingly, the drawings and descriptions should be regarded as illustrative in nature and not as restrictive.

### BRIEF DESCRIPTION OF DRAWINGS

The accompanying drawings incorporated in and forming a part of the specification, illustrate embodiments of the present invention. Some, although not all, alternative embodiments are described in the following description.

In the drawings:

FIG. 1 is an exterior drawing of the present embodiment of the filter of this invention installed in a tank.

FIG. 2 is a section view of the filter of this invention installed in a tank.

Reference will now be made in detail to the present preferred embodiments of the invention, examples of which are illustrated in the accompanying drawings.

### DETAILED DESCRIPTION

This invention is a self-cleaning/self-purging filtration system. Using teflon-copolymer composites or the like for the filters as an integral part of the reaction or precipitation vessel this invention permits continuously or intermittently cleaned. This invention accomplishes continuously cleaning by employing ultra-sound transducers to generate an ultra-sonic vibration in the filter medium. The intermittent cleaning can be accomplished either through selective use of the ultra-sound transducers and/or backwash pressure within the vessel. This invention is also designed to fit within a standard precipitation or reaction vessel, thereby eliminating or minimizing the need for filtration equipment downstream of the precipitation or reaction operation.

This invention is designed for use in industrial, pharmaceutical, commercial and municipal processing and/or waste water treatment applications where the removal of undesirable contaminants is desirable. Technologies using coagulation or chelating chemistry is enhanced by the filtering of the precipitates formed within a holding tank or reaction vessel during the reaction and/or settling process. Food processing, mining, desalinating, industrial, wastewater and sewage treatment plants can use the invention as a pre-treatment or post-treatment of the incoming or outgoing effluent streams, especially during precipitation reactions for removal of organic or inorganic compounds.

This invention also reduces the space, typically required by sand and other commonly used filters, in industrial and manufacturing processes, since it is enclosed within a reaction chamber or other similar type of tank or vessel where it is desirable to remove particles or solids from liquid phase materials. This filter design is designed to be efficient and capable of reducing processing time and cost, along with reducing the need for additional filtering vessels or filtration systems.

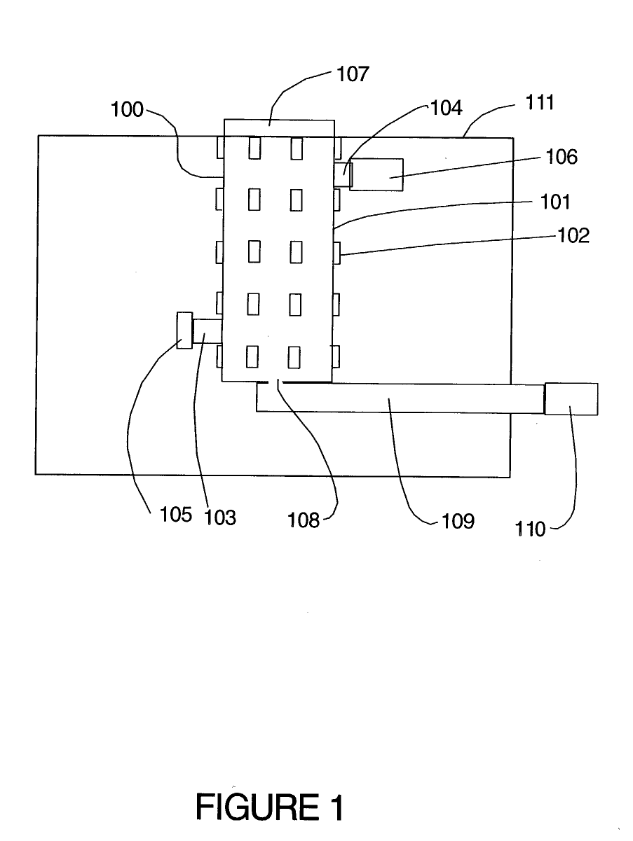

FIG. 1 shows an exterior drawing of the present embodiment of the filter of this invention installed in a tank. The filter assembly 100 of this invention is positioned within a tank 111 or other vessel containing materials for filtering. The filter assembly 100 has an exterior wall 101 about which is located a number of ultra-sound transducers 102. An inlet port 103′ provides a port for the receipt of material to be filtered. The inlet port 103 can be provided with an inlet valve 105. An outlet port 104 provides a port for the exit of filtered material. This outlet port 104 is typically connected to a pump/valve device 106 for drawing filtered liquid from the filter. Generally, the inlet 103 is positioned lower than the outlet 104 because of the general tendency of particulates to settle in the lower portions in a vessel. Although in alternative embodiments, the inlet 103 and outlet 104 may be relocated without departing from the concept of this invention to maximize the efficiency of the filter. A top lid 107 also provides access to the interior for filter replacement and maintenance. A particle discharge port 108 is provided in fluid communication 109 with the exterior of the tank 111. The communication channel 109 is presently provided with a valve/pump 110 for providing intermittent backpressure and/or for drawing refuse particles from the filter. The ultra sound transducers 102 are designed to provide ultrasonic vibrations to the filter and/or fluid within the filter assembly 100.

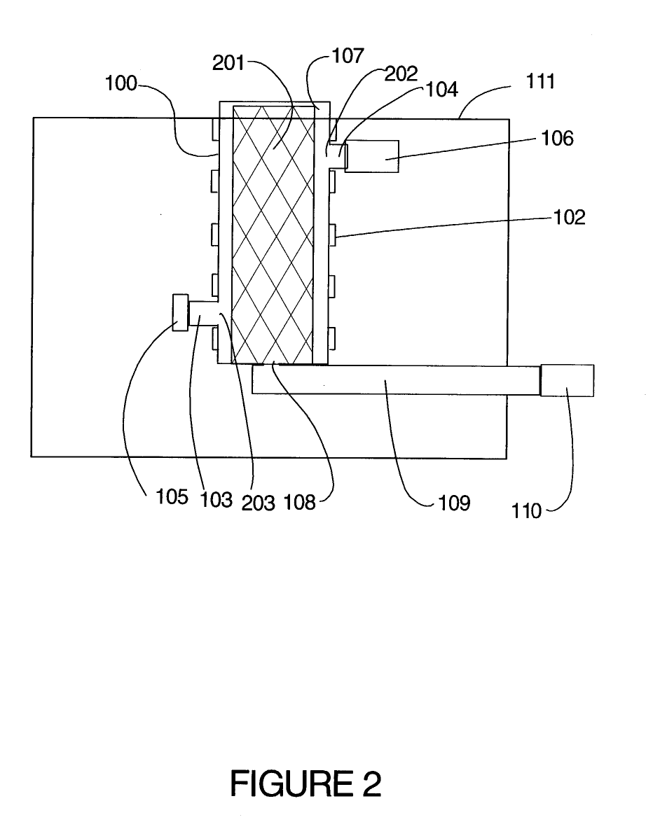

FIG. 2 shows a section view of the filter of this invention installed in a tank. This view shows the filter medium 201 within the filter assembly 100. The present preferred filter medium 201 is teflon-copolymer composite mesh woven to filter particles of a desired size. The inlet 103 communication channel 203 and the outlet 104 communication channel 202 are also shown.

The described embodiments are to be considered in all respects only as illustrative of the current best modes of the invention known to the inventors at the time of filing this application, and not as restrictive. Although the embodiments shown here include specific geometries and components, these are provided in order to show examples of the present embodiments of this invention. Rather, the geometries are provided to show several examples. This scope of this invention is, therefore, indicated by the appended claims rather than by the foregoing description. All devices and processes that come within the meaning and range of equivalency of the claims are to be embraced as within the scope of this patent.

1. A filter system, comprising:
(A) an exterior wall;
(B) an inlet port in said exterior wall;
(C) an outlet port in said exterior wall;
(D) a composite filter media; and
(E) an ultra sound source adapted to produce ultrasonic vibration within said exterior wall.

2. A filter system, as recited in claim 1, further comprising:
(F) a valve connected to said inlet port to control the input of fluid within said exterior wall.

3. A filter system, as recited in claim 1, further comprising:
(G) a pump/valve connected to said outlet port to control the draw of fluid through said filter system.

4. A filter system, as recited in claim 1, further comprising:
(H) a backwash channel attached to said exterior wall of said filter system.

5. A filter system, as recited in claim 1, wherein said composite fiber media is composed of a ceramic teflon-copolymer composites.

6. A filter system, as recited in claim 1, further comprising a vessel, adapted for holding a fluid for filtering, about said exterior wall of said filter system.
